(19) United States
(12) Patent Application Publication
(10) Pub. No.: US 2019/0024467 A1
(43) Pub. Date: Jan. 24, 2019

(54) METHOD FOR ORIENTING WHIPSTOCK FOR CASING EXIT IN VERTICAL AND NEAR VERTICAL WELLS USING XY MAGNETOMETERS

(71) Applicants: Lei Yang, Houston, TX (US); Lei Fang, Katy, TX (US)

(72) Inventors: Lei Yang, Houston, TX (US); Lei Fang, Katy, TX (US)

(73) Assignee: Baker Hughes, a GE company, LLC, Houston, TX (US)

(21) Appl. No.: 15/656,256

(22) Filed: Jul. 21, 2017

(51) Int. Cl. E21B 23/01; G01C 17/04; E21B 47/04; E21B 47/024

(52) U.S. Cl. CPC E21B 23/01; G01C 17/04; E21B 7/061; E21B 47/024; E21B 47/04

(57) ABSTRACT

A system and method for orienting a tool in a near vertical wellbore. The system includes a tool string having a whipstock at an end thereof, at least two magnetometers oriented transverse to a longitudinal axis of the tool string, and a processor. A first set of magnetic measurements of the earths' magnetic field is obtained during rotation of the tool using a first of the at least two magnetometers and a second set of magnetic measurements of the earth's magnetic field is obtained during rotation using a second of the at least two magnetometers. The processor fits a curve to the first and second sets of magnetic measurements to determine a peak value, determines magnetic north from the determined peak value, determines a toolface orientation of the drill string with respect to the determined magnetic north, and anchors the whipstock at the selected depth and toolface orientation.

### BACKGROUND

Whipstocks are used in wellbore drilling in order to divert a drill string from a pre-existing holes toward a new direction. Often whipstocks are employed in cased wellbores and the drill string is diverted for a casing exit. It is important to know the orientation of the whipstock so that the drill string is diverted along a desired direction. In a horizontal or deviated wellbore, accelerometers can be used to determine a whipstock orientation or an orientation of a string conveying the whipstock. However in vertical and near vertical wells, where well inclination is less than 5 degrees, accelerometer measurements are unable to determine toolface angle, as a result of which a gyroscope is usually used to determined true-north measurements.

### BRIEF DESCRIPTION

In one aspect, the present disclosure provides a method of orienting a tool in a near vertical wellbore, including: rotating the tool at a selected depth of the vertical wellbore, the tool including at least two magnetometers oriented transverse to a longitudinal axis of the tool; obtaining, during rotation of the tool, a first set of magnetic measurements of the earth's magnetic field using a first of the at least two magnetometers and a second set of magnetic measurements using a second of the at least two magnetometers; fitting a curve to the first and second sets of magnetic measurements to determine a peak value; determining magnetic north from the determined peak value; and orienting the tool along a selected orientation based on the determined magnetic north.

In another aspect, the present disclosure provides a system for placing a whipstock in a near vertical wellbore, including: a tool string having the whipstock at an end thereof, the tool string including at least two magnetometers oriented transverse to a longitudinal axis of the tool string; a processor configured to: obtain, during rotation of the tool in the wellbore, a first set of magnetic measurements of the earth's magnetic field using a first of the at least two magnetometers and a second set of magnetic measurements using a second of the at least two magnetometers, fit a curve to the first and second sets of magnetic measurements to determine a peak value, determine magnetic north from the determined peak value, determine a toolface orientation of the drill string with respect to the determined magnetic north, and anchor the whipstock at the selected depth and toolface orientation.

### BRIEF DESCRIPTION OF THE DRAWINGS

The following descriptions should not be considered limiting in any way. With reference to the accompanying drawings, like elements are numbered alike:

FIG. 1 illustrates a drilling system that includes a milling tool string conveying a whipstock into a vertical wellbore for placement in the wellbore;

FIG. 2 shows a detailed illustration of a section of drill string in an exemplary embodiment of the present disclosure;

FIG. 2A shows a view of the section of the milling tool string in another embodiment;

FIG. 3 shows a flowchart illustrating a method for setting a whipstock in a vertical wellbore or a vertical section of a wellbore according to an embodiment of the present invention; and

FIG. 4 illustrates magnetic field measurements that can be obtained using the at least two magnetometers of the downhole tool at the selected depth in the wellbore.

### DETAILED DESCRIPTION

A detailed description of one or more embodiments of the disclosed apparatus and method are presented herein by way of exemplification and not limitation with reference to the Figures.

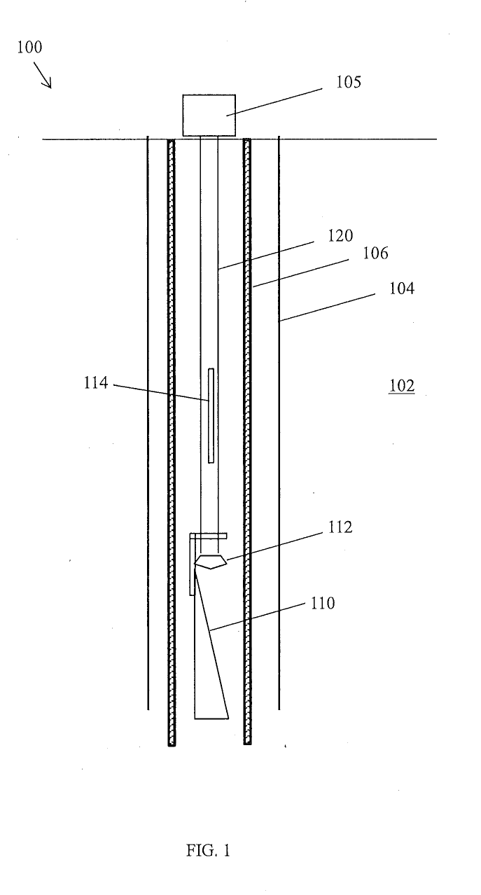

FIG. 1 illustrates a drilling system 100 that includes a tool string 120 conveying a whipstock 110 into a vertical wellbore 104 for placement in the wellbore 104. In various embodiments, the tool string 120 can be a milling tool string or a drill string for drilling the wellbore 104. A milling tool string can include a mill 112 at a bottom end thereof, and a drill string can include a drill bit at a bottom end thereof. The wellbore 104 can be a vertical wellbore or a near vertical wellbore, whereas a near vertical wellbore deviates from vertical by less than about 5 degrees. Wellbore 104 is formed in formation 102 and includes a casing 106 therein. The tool string 120 is conveyed from drilling rig 105 for a casing exit operation. In the casing exit operation, the whipstock 110 is conveyed to a selected depth of the wellbore 104 and rotated until its toolface angle is at a selected orientation. The whipstock 110 is then anchored in the casing 106 at the selected depth and orientation and detached from the tool string 120. The tool string 120 is then lowered with the mill 112 rotating. As the tool string 120 is lowered, the whipstock 110 diverts the mill 112 into the casing 106, thereby causing the mill 112 to drill an exit from the wellbore 104 through the casing 106. In the illustrative example, the whipstock 110 is anchored within the casing 106. However, the whipstock 110 can also be anchored in an encased region of the wellbore 104 in other embodiments.

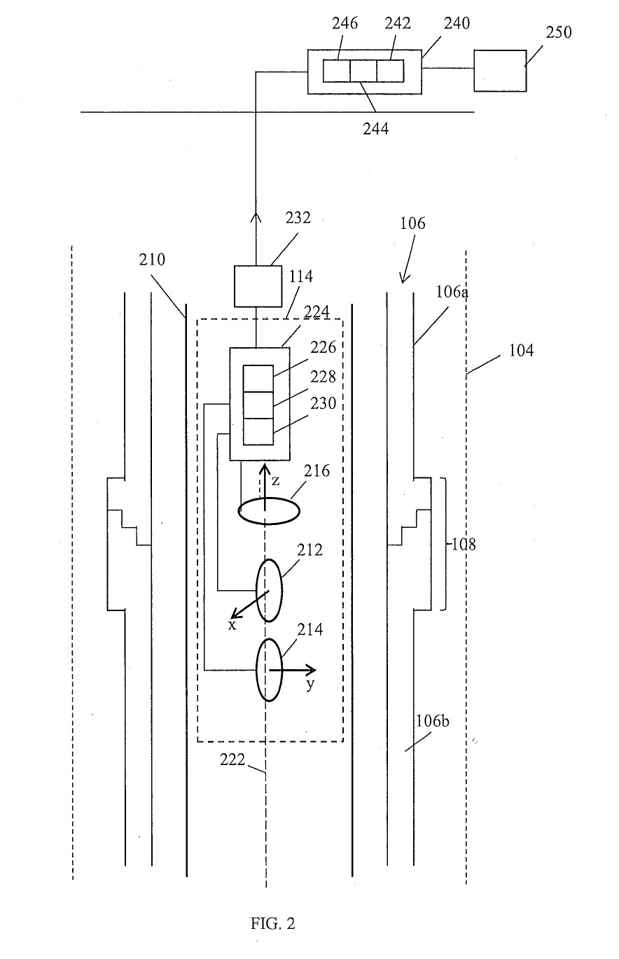

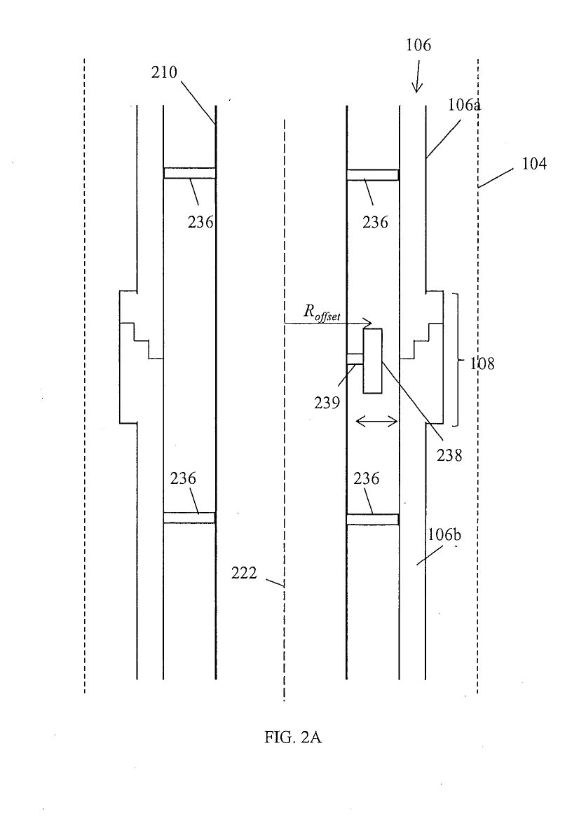

The tool string 120 includes a bottomhole assembly (BHA) 114 that includes sensors for taking various survey measurements of the wellbore 104. The BHA 114 can include accelerometers for measuring movement of the tool string 120 as well as for providing toolface orientation in horizontal or deviated wellbores. The BHA 114 may also include magnetometers for measuring a magnetic field within the casing 106. The magnetic field measurements can be used to determine a depth of the tool string 120 in the wellbore by measuring the disturbance of the magnetic field of the earth due to the presence of the casings and, in particular, the presence of the casing collars. Additionally, the magnetic field measurements can be used to measure the Earth's magnetic field to thereby determine magnetic North. The magnetic measurements can also be used to determine the spinning speed of the BHA 114 during the milling process. The determined magnetic North can be used to orient at the tool string 120 and hence the whipstock 110 within the vertical wellbore 104. A detailed description of the BHA 114 is provided below with respect to FIGS. 2 and 2A.

FIG. 2 shows a detailed illustration of a section 210 of tool string 120 in an exemplary embodiment of the present disclosure. The section 210 includes a BHA 114 that includes various sensors suitable for determining orientation and placement of a whipstock 110 in a wellbore 104. In one embodiment, the sensors include at least two magnetometers, with each magnetometer having a measurement axis oriented in a selected direction. A tool-based coordinate system describes orthogonal x-, y- and z-axes, with the z-axis directed along a longitudinal axis 222 of the tool string 120 and the x-axis and y-axis lying within a plane transverse to the longitudinal axis 222. An x-directed magnetometer 212 is oriented so as to measure magnetic components (Mₓ) that are along the x-axis of the tool-based coordinate system. A y-directed magnetometer 214 is oriented so as to measure magnetic components (M_{y}) that are along the y-axis of the tool-based coordinate system. A z-directed magnetometer 216 is oriented so as to measure magnetic components (M_{z}) along the z-axis of the tool-based coordinate system. In various embodiments of the present invention, the z-directed magnetometer 216 is not necessary to perform the methods of orienting the tool string 120 and can thus be left off of the tool string 120.

The transverse magnetometers (212, 214) of the tool string 120 obtain magnetic measurements of the casing 106 as the tool string 120 is conveyed through the wellbore 104. The measurements may be individual measurements or in the form of a magnetic log. Measurements made by the x-directed magnetometer 212 and the y-directed magnetometer 114 may be sent to a processing unit 224 of the BHA 114 that may include a processor 226, various programs 228 for implementing methods for determining an orientation of the tool string 120, and a memory 230 for storing data. In addition, the tool string 120 may include a telemetry unit 232 that may be used to transmit data to a surface location and to receive data from a surface location. One or more of the magnetic measurements may be sent via the telemetry unit 232 to a processing unit 240 at the surface location that includes processor 242, programs 244 and memory 246 for determining the orientation of the tool string 120 using the methods disclosed herein. The processing units 224 and 240 may also include programs for determining depth of the tool string 120 and or orienting the toolface of the tool string 120 to a selected orientation. The results of the processing may be sent to a display 250 for viewing by an operator or user.

FIG. 2A shows a view of section 210 of the tool string 120 in another embodiment. The magnetometers 212, 214 and/or 216 may be disposed on a member 238 that is extendable radially by arm 239 so that the magnetometers 212, 214 and/or 216 can either be disposed along the longitudinal axis 222 or extended from the longitudinal axis 222 by a selected offset R_{offset}. When articulated from the longitudinal axis, one of the x-directed magnetometer 212 and the y-directed magnetometer 214 may be oriented with its measurement axis directed along a radial line of the casing 100 while the other of the x-directed magnetometer 212 and y-directed magnetometer 214 may be oriented with its measurement axis directed in a circumferential direction.

The section 210 may include one or more stabilizers 236 that hold the section 210 in place within the casing 106 while magnetic measurements are being obtained. The azimuth or toolface angle can also be changed, generally by rotation of the section 210 via a motor (not shown) at either a surface location or a downhole location.

Referring to either FIG. 2 or FIG. 2A, the casing 106 may be an assembly of multiple casing tubulars. In one embodiment, casing 106, including the first casing tubular 106a and the second casing tubular 106b, is made of a non-magnetized material or a soft magnetic material that does not carry a residual magnetic field. However, an applied magnetic field proximate the casing induces a magnetic field in the casing 106. Thus, in the downhole environment the magnetic field of the Earth induces a magnetic field in casing 106.

In one embodiment, the first casing tubular 106a is fastened to the second casing tubular 106b via a threaded surface on an exterior surface of the first casing tubular 106a and a threaded surface on an interior surface of the second casing tubular 106b. In general, the casing tubulars 106a, 106b carry substantially homogenous induced magnetic fields along their length. The casing joint or collar 108 however introduces a perturbation into the induced magnetic field that can be detected to determine depth of the downhole tool in the wellbore.

In one aspect, a configuration of the magnetometers 212, 214 is selected that provides suitable magnetic measurements for determining the toolface angle using the methods disclosed herein. For example, an optimal or suitable offset for the magnetometers 212, 214 can be determined. In various embodiments, the configuration of the magnetometers 212, 214 can be determined using a computer simulation or by testing the configuration at the surface location or within the first casing of the wellbore.

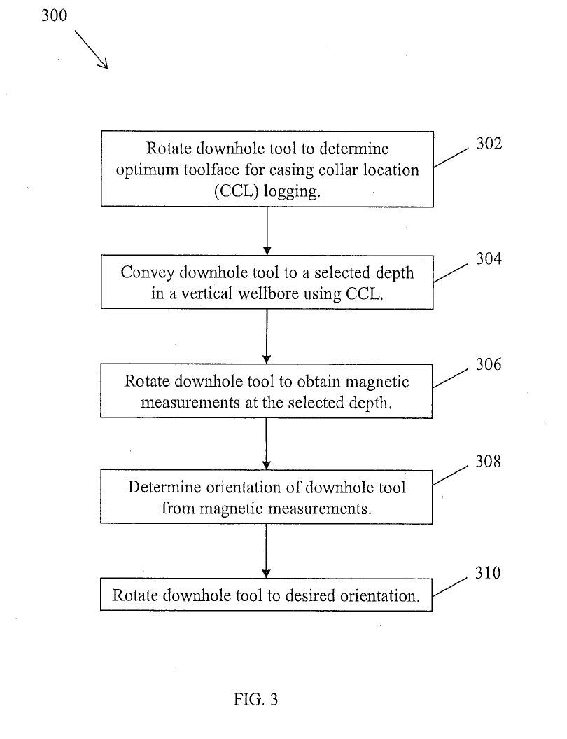

FIG. 3 shows a flowchart 300 illustrating a method for setting a whipstock in a vertical wellbore or a vertical section of a wellbore according to an embodiment of the present invention. In Box 302, the downhole tool (e.g., tool string 120) conveying the whipstock is rotated to determine an optimal configuration of the tool string 120 for obtaining casing collar location logging. In various embodiments, the tool string 120 includes at least two magnetometers, such as magnetometers 212 and 214 that lie in a plane transverse to the longitudinal axis of the tool string 120. The configuration may include a selected offset of the magnetometers from the longitudinal axis of the tool string 120, for example. In box 304, the downhole tool is conveyed downhole to a selected depth within the wellbore using, for example, casing collar locating (CCL) logging from magnetic measurements obtained by the at least two magnetometers in the configuration determined in box 302. The CCL log can be used to position the magnetometers 212 and 214 at a location away from the casing collars 108, where magnetic measurements obtained for determining orientation are unaffected by any magnetic disturbances due to casing collars 108. In box 306, once the selected depth of the downhole tool has been reached, the downhole tool is rotated so that magnetic measurements can be obtained at a plurality of azimuthal angles (i.e., over at least a 360-degree range). The magnetic measurements include measurements of a magnetic field induced in the casing by the Earth's magnetic field. In box 308, the orientation of the downhole tool is determined from the magnetic measurements obtained at the plurality of azimuthal angles. In box 310, the downhole tool is rotated from its determined orientation to a desired or selected toolface orientation. The rotation is made by determining an angular difference between the determine toolface orientation of the tool and the desired toolface orientation of the tool and measuring a rotation of the downhole tool as the downhole tool is rotated through the angular difference to achieve desired toolface orientation.

The magnetometer measurements are often weak and/or noisy due to such effects as the damping effect of the casing on the strength of the Earth's magnetic field in the wellbore, residual magnetic fields of casing, a transverse offset of the tool string from the casing axis, the tool string not being parallel with casing axis, etc. The processing method discussed below can be used to determine the direction of magnetic north.

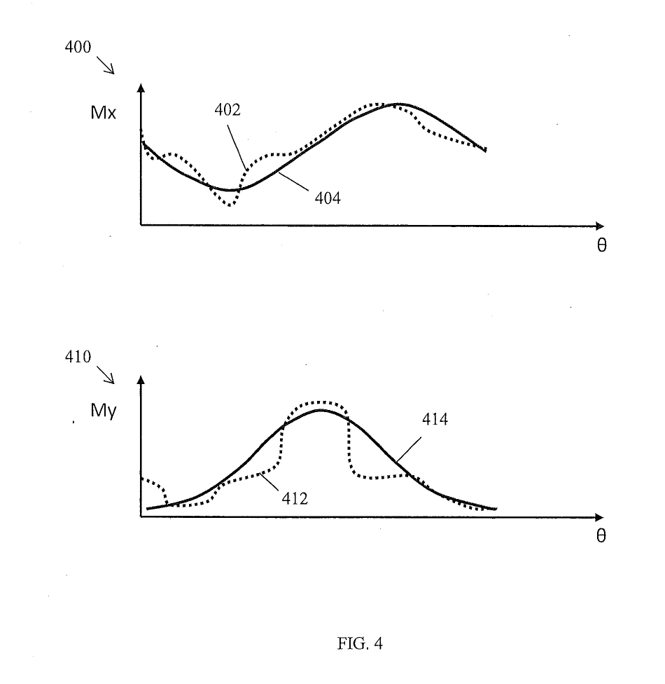

FIG. 4 illustrates magnetic field measurements that can be obtained using the at least two magnetometers of the downhole tool at the selected depth in the wellbore. Graph 400 shows magnetic measurements Mₓ 402 obtained using the x-directed magnetometer 212 as the downhole tool is rotated through a plurality of azimuthal angles, such as through a 360-degree rotation of the downhole tool. Although magnetic measurements obtained through a rotation of 360-degree would appear to be sinusoidal, the magnetic measurements Mₓ 402 are generally not perfect sinusoids due to distortion by the casing 106. In order to smooth the measurements Mₓ 402, sinusoidal curve 404 is fit to magnetic measurements Mₓ 402 using a suitable fitting program. Once the curve 404 has been fit, a peak value of the curve 404 can be selected as representative of magnetic north.

Graph 410 shows magnetic measurements M_{y} 412 obtained using the y-directed magnetometer 214 as the downhole tool is rotated through a plurality of azimuthal angles, specifically through a 360-degree rotation of the downhole tool. Magnetic measurements M_{y} 412 similarly diverge from a sinusoidal curve for the same reasons presented above with respect to measurements Mₓ 402. Sinusoidal curve 414 can therefore be fit to magnetic measurements M_{y} 412 using a suitable fitting program. Once the curve 414 has been fit, a peak value of the curve 414 can be selected as representative of magnetic north.

In one embodiment, sinusoidal curves 404 and 414 are fit to their respective magnetic measurements Mₓ 402 and M_{y} 412 with the constraint that a 90-degree phase difference is maintained between them. The peak values from curves 404 and 414 can be used to determine an orientation of the downhole tool with respect to magnetic north. Once the orientation of the downhole tool has been determined, the downhole tool can be rotated into a desired orientation. In one embodiment, the downhole tool can be rotated from its determined current orientation to the desired orientation by determining an angular difference between determined orientation and desired orientation and tracking angular rotation of the downhole tool with a suitable rotation sensor through the angular difference until the desired orientation has been reached. Once the desired toolface orientation is achieved, the whipstock can be anchored into the casing and released from the downhole tool in preparation for a next stage of a casing exit operation. Additional operation that required a selected orientation in a vertical wellbore can also be performed by determining the orientation using the methods disclosed herein.

The method of the present invention enables conducting a single trip casing exit operation in a vertical wellbore. The at least two magnetometers orthogonal to the longitudinal axis of the downhole tool can be used for both CCL logging to determine tool (e.g., whipstock) depth and for orienting the tool. When drilling with a drill string, once the drill string has exited the vertical wellbore, the drill string can continue to drill to obtain a deviated well using the magnetometers as well as any accelerometers that may be provided with the drill string.

Set forth below are some embodiments of the foregoing disclosure:

### Embodiment 1

A method of orienting a tool in a near vertical wellbore, including: rotating the tool at a selected depth of the near vertical wellbore, the tool including at least two magnetometers oriented transverse to a longitudinal axis of the tool; obtaining, during rotation of the tool, a first set of magnetic measurements of the earth's magnetic field using a first of the at least two magnetometers and a second set of magnetic measurements using a second of the at least two magnetometers; fitting a curve to the first and second sets of magnetic measurements to determine a peak value; determining magnetic north from the determined peak value; and orienting the tool along a selected orientation based on the determined magnetic north.

### Embodiment 2

The method of embodiment 1 further comprising conveying the tool to the selected depth using magnetic measurements of a casing in the wellbore obtained by the at least two magnetometers.

### Embodiment 3

The method of embodiment 1, wherein orienting the tool further comprises determining a first orientation of the tool with respect to magnetic north, determining an angular difference between the selected orientation and the first orientation and measuring a rotation of the tool through the angular difference.

### Embodiment 4

The method of embodiment 1, wherein the at least two magnetometers includes a first magnetometer oriented along a first radial direction orthogonal to a longitudinal axis of the tool and a second magnetometer oriented along a second radial direction orthogonal to both the first radial direction and the longitudinal axis of the tool.

### Embodiment 5

The method of embodiment 1, further comprising fitting a first sinusoidal curve to the first set of magnetic measurements and fitting a second sinusoidal curve to the second set of magnetic measurements, wherein the first sinusoidal curve and the second sinusoidal curve are 90 degrees out of phase.

### Embodiment 6

The method of embodiment 5, further comprising determining magnetic north from a peak of the first sinusoidal curve and a peak of the second sinusoidal curve.

### Embodiment 7

The method of embodiment 1, wherein the tool includes a whipstock and setting the tool further comprises anchoring the whipstock at the selected orientation.

### Embodiment 8

The method of embodiment 1, further comprising obtaining the magnetic measurements with the at least two magnetometers offset from the longitudinal axis of the tool.

### Embodiment 9

A system for placing a whipstock in a near vertical wellbore, including: a tool string having the whipstock at an end thereof, the tool string including at least two magnetometers oriented transverse to a longitudinal axis of the tool string; a processor configured to: obtain, during rotation of the tool in the wellbore, a first set of magnetic measurements of the earth's magnetic field using a first of the at least two magnetometers and a second set of magnetic measurements using a second of the at least two magnetometers, fit a curve to the first and second sets of magnetic measurements to determine a peak value, determine magnetic north from the determined peak value, determine a toolface orientation of the drill string with respect to the determined magnetic north, and anchor the whipstock at the selected depth and toolface orientation.

### Embodiment 10

The system of embodiment 9, wherein the processor is further configured to determine a selected depth of the drill string using casing collar location measurements obtained by the at least two magnetometers.

### Embodiment 11

The system of embodiment 9, wherein the processor is further configured to obtain a selected toolface orientation by determining the toolface orientation of the drill string with respect to magnetic north, determining an angular difference between the selected toolface orientation and the determined toolface orientation and measuring a rotation of the tool through the angular difference.

### Embodiment 12

The system of embodiment 9, wherein the at least two magnetometers includes a first magnetometer oriented along a first radial direction orthogonal to the longitudinal axis of the drill string and a second magnetometer oriented along a second radial direction orthogonal to both the first radial direction and the longitudinal axis of the drill string.

### Embodiment 13

The system of embodiment 9, wherein the processor is further configured to fit a first sinusoidal curve to the first set of magnetic measurements and fit a second sinusoidal curve to the second set of magnetic measurements, wherein the first sinusoidal curve and the second sinusoidal curve are 90 degrees out of phase.

### Embodiment 14

The system of embodiment 13, wherein the processor is further configured to determine magnetic north from a peak of the first sinusoidal curve and a peak of the second sinusoidal curve.

### Embodiment 15

The system of embodiment 9, wherein the at least two magnetometers offset from the longitudinal axis of the tool.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of orienting a tool in a near vertical wellbore, comprising:
rotating the tool at a selected depth of the near vertical wellbore, the tool including at least two magnetometers oriented transverse to a longitudinal axis of the tool;
obtaining, during rotation of the tool, a first set of magnetic measurements of the earth's magnetic field using a first of the at least two magnetometers and a second set of magnetic measurements using a second of the at least two magnetometers;
fitting a curve to the first and second sets of magnetic measurements to determine a peak value;
determining magnetic north from the determined peak value; and
orienting the tool along a selected orientation based on the determined magnetic north.

2. The method of claim 1, further comprising conveying the tool to the selected depth using magnetic measurements of a casing in the wellbore obtained by the at least two magnetometers.

3. The method of claim 1, wherein orienting the tool further comprises determining a first orientation of the tool with respect to magnetic north, determining an angular difference between the selected orientation and the first orientation and measuring a rotation of the tool through the angular difference.

4. The method of claim 1, wherein the at least two magnetometers includes a first magnetometer oriented along a first radial direction orthogonal to a longitudinal axis of the tool and a second magnetometer oriented along a second radial direction orthogonal to both the first radial direction and the longitudinal axis of the tool.

5. The method of claim 1, further comprising fitting a first sinusoidal curve to the first set of magnetic measurements and fitting a second sinusoidal curve to the second set of magnetic measurements, wherein the first sinusoidal curve and the second sinusoidal curve are 90 degrees out of phase.

6. The method of claim 5, further comprising determining magnetic north from a peak of the first sinusoidal curve and a peak of the second sinusoidal curve.

7. The method of claim 1, wherein the tool includes a whipstock and setting the tool further comprises anchoring the whipstock at the selected orientation.

8. The method of claim 1, further comprising obtaining the magnetic measurements with the at least two magnetometers offset from the longitudinal axis of the tool.

9. A system for placing a whipstock in a near vertical wellbore, comprising:
a tool string having the whipstock at an end thereof, the tool string including at least two magnetometers oriented transverse to a longitudinal axis of the tool string;
a processor configured to:
obtain, during rotation of the tool in the wellbore, a first set of magnetic measurements of the earth's magnetic field using a first of the at least two magnetometers and a second set of magnetic measurements using a second of the at least two magnetometers,
fit a curve to the first and second sets of magnetic measurements to determine a peak value,
determine magnetic north from the determined peak value,
determine a toolface orientation of the drill string with respect to the determined magnetic north, and
anchor the whipstock at the selected depth and toolface orientation.

10. The system of claim 9, wherein the processor is further configured to determine a selected depth of the drill string using casing collar location measurements obtained by the at least two magnetometers.

11. The system of claim 9, wherein the processor is further configured to obtain a selected toolface orientation by determining the toolface orientation of the drill string with respect to magnetic north, determining an angular difference between the selected toolface orientation and the determined toolface orientation and measuring a rotation of the tool through the angular difference.

12. The system of claim 9, wherein the at least two magnetometers includes a first magnetometer oriented along a first radial direction orthogonal to the longitudinal axis of the drill string and a second magnetometer oriented along a second radial direction orthogonal to both the first radial direction and the longitudinal axis of the drill string.

13. The system of claim 9, wherein the processor is further configured to fit a first sinusoidal curve to the first set of magnetic measurements and fit a second sinusoidal curve to the second set of magnetic measurements, wherein the first sinusoidal curve and the second sinusoidal curve are 90 degrees out of phase.

14. The system of claim 13, wherein the processor is further configured to determine magnetic north from a peak of the first sinusoidal curve and a peak of the second sinusoidal curve.

15. The system of claim 9, wherein the at least two magnetometers offset from the longitudinal axis of the tool.
